(19) United States
(12) Patent Application Publication
(10) Pub. No.: US 2011/0026356 A1
(43) Pub. Date: Feb. 3, 2011

(54) APPARATUS AND METHODF FOR THE UNIFORM DISTRIBUTION OF MICROPARTICLES IN A LIQUID

(75) Inventors: Jörg Feldhusen, Korschenbroich (DE); Hartmut Schlüter, Osnabruck (DE); Joachim Thiemann, Berlin (DE); Johannes Lemburg, Aachen (DE)

Correspondence Address: LONDA, BRUCE S.;NORRIS MCLAUGHLIN & MARCUS, PA, 875 THIRD AVE, 8TH FLOOR, NEW YORK, NY, 10022, US

(73) Assignee: CHARITÉ - UNIVERSITÄTSMEDIZIN BERLIN, Berlin (DE)

(21) Appl. No.: 12/680,712

(22) PCT Filed: Sep. 26, 2008
(86) PCT No.: PCT/EP08/62905

§ 371 Date: Oct. 18, 2010

(30) Foreign Application Priority Data
Sep. 27, 2007 (DE) 10 2007 047 478.6

(51) Int. Cl. B01F 13/02

(52) U.S. Cl. 366/107; 901/50

(57) ABSTRACT

The invention relates to an apparatus for the uniform distribution of microparticles in a liquid, said apparatus comprising a storage chamber 1 including a suspension of microparticles and liquid, a mixing head 2 for receiving the suspension, and a pump 3 which is connected to the storage chamber 1 and the mixing head 2 for sucking the suspension from the storage chamber 1 into the mixing head 2, said mixing head 2 having at least one well 4 with a flow turbulator 5 and an overflow 6 which is connected to the storage chamber 1 via an opening 7, characterized in that the storage chamber 1 has a pin 14 and/or a rotary inlet 15 and a rotary runback 16 which are connected to the pump 3. The apparatus can be used for the identification, characterization and purification of proteins. The invention is also directed to a method for the uniform distribution of microparticles in a liquid, which method generates a turbulent, quasi-static state.

The invention relates to an apparatus for producing a suspension with uniformly distributed microparticles in a carrier liquid or maintaining uniform distribution of microparticles in the carrier liquid. The apparatus comprises a storage chamber 1 including the suspension, a mixing head 2 and a pump 3 which is connected to the storage chamber 1 and the mixing head 2, said mixing head 2 having at least one well 4 with a flow turbulator 5 and an overflow 6 which is connected to the storage chamber 1 via an opening 7, characterized in that the storage chamber 1 has a pin 14 and/or a rotary inlet 15 and a rotary runback 16 which are connected to the pump 3. The apparatus can be used for the identification, characterization and purification of proteins. The invention is also directed to a method for the uniform distribution of microparticles in a liquid, which method generates a turbulent, quasi-static state.

The ongoing automation of operations in laboratory technology is largely based on parallel sample processing. In this context, microparticles which are plastic beads of from a few micrometers to about 0.1 mm in size, the surfaces of which have specific reactive properties, have gained more and more importance in proteome research. After production, these microparticles are stored in a protective carrier liquid, forming a suspension with the latter. One fundamental problem in handling microparticles is dosage of constant amounts of such particles on a large number of sample carriers. Direct weighing or counting of the microparticles has to be ruled out because they cannot or may not be withdrawn from the carrier liquid.

As is well-known in the prior art, indirect metering of the amount of particles is possible via metering the volume of the carrier liquid. This type of quantity measurement implies the assumption that the microparticles are uniformly distributed in the carrier liquid. However, this assumption is not consistently applicable because the microparticles generally have a higher density than the carrier liquid and therefore tend to undergo sedimentation. Consequently, depending on the site of sampling, there are microparticles in an amount higher than average in a sample near the bottom and lower than average in a sample near the surface.

Various apparatus and methods for constant distribution of microparticles in a liquid have been proposed in the prior art. The patent document U.S. Pat. No. 6,255,166 B1 discloses an apparatus which enables mixing of microparticles in suspension by agitating the liquid using vertical up-and-down motion of a blade. What is disadvantageous is the input of energy required for the external stirring element and the fact that the blade is situated inside the vessel, thereby impeding withdrawal or analysis of the suspension.

The patent document U.S. Pat. No. 5,705,610 teaches an apparatus comprising mixing and reaction vessels allowing transportation of reagents or suspensions therebetween which can be mixed by feeding gas. However, the supply of gas, which is accompanied by formation of bubbles, is critical both under process-technological aspects (increase in volume, unequal volumes of liquid during sampling, etc.) and with respect to the sensitivity of biological structures.

Furthermore, an apparatus is known from WO 2007/064635 A1, which operates without air passage by moving a suspension through an opening between two pumps/mixing chambers and removing the mixed suspension through a valve port. The apparatus requires complex cooperation of the two pumps and precludes sampling in the turbulent zone.

The basic object of the invention is to overcome the drawbacks in mixing microparticles in suspensions as evident from the prior art and develop an apparatus ensuring reliable quantity measurement of microparticles.

The object of the invention is accomplished in accordance with the independent claims. The subclaims relate to preferred embodiments. According to the invention, an apparatus for uniformly distributing microparticles in a liquid is provided, said apparatus comprising a storage chamber 1 including a suspension of microparticles and liquid, a mixing head 2 for receiving the suspension, and a pump 3 which is connected to the storage chamber 1 and the mixing head 2 for suctioning the suspension from the storage chamber 1 into the mixing head 2, said mixing head 2 having at least one well 4 with a flow turbulator 5 and an overflow 6 which is connected to the storage chamber 1 via an opening 7, characterized in that the storage chamber 1 has a pin 14 and/or a rotary inlet 15 and a rotary runback 16 which are connected to the pump 3.

It was found that separating the storage chamber 1 and the mixing head 2, fitting a flow turbulator 5 in the well 4 of mixing head 2, and connecting the above-mentioned structural elements into a circulation not only results in constant microparticle distribution at the site of interest, but also generates a quasi-static state in the well 4. The site of interest is the interface 8 to the adjoining laboratory system 10, by means of which the microparticles or associated structures included in the suspension can be withdrawn and/or analyzed. The structures preferably comprise biomolecules such as proteins, nucleic acids, peptides, carbohydrates, polymers or molecules having a molecular weight between 50 and 1,000 Da, or microorganisms or eukaryotic cells.

According to the invention, the storage chamber 1 has a pin 14 and/or a rotary inlet 15 and a rotary runback 16 which are connected to the pump 3. These components are especially advantageous in generating a second suspension circulation which prevents sedimentation of the microparticles in the storage chamber 1. Although the microparticles conveyed between storage chamber 1 and mixing head 2 in the first circulation are uniformly distributed in the carrier liquid in well 4, their concentration might drop over time. This would be the case if, for example, microparticles sedimented in the storage chamber 1 are withdrawn by suction during the initial phase and a suspension depleted in particles is withdrawn by suction during the further course. Thus, by virtue of the pin 14 and/or the rotary inlet 15 and rotary runback 16, not only uniform distribution in a cycle of the first circulation is achieved, but also maintenance of a suspension with constant distribution over the entire time course of operating the apparatus. The time course is determined by the filling volume of the storage chamber 1 with suspension and the successive withdrawal thereof from the well 4. In this embodiment the pump 3 conveys the suspension in two parallel circulations. The additional second circulation causes rotation of the suspension in the storage chamber 1 in such a way that the suspension is aspirated by the rotary runback 16, conveyed in a rotary loop and subsequently transferred back into the storage chamber at the rotary inlet 15. In a preferred fashion the rotary inlet 15 and the rotary runback 16 are arranged at different levels of the storage chamber 1. In case the rotary circulation nevertheless produces only a laminar flow, which does not sufficiently prevent sedimentation of the microparticles at the bottom of the chamber 1, the rotating flow can be made turbulent by means of a flow turbulator 5, as represented by the pin 14. In the stagnant water of pin 14 a suction means 17 is arranged by means of which suspension is supplied to the mixing head 2.

In addition, the apparatus according to the invention consists of two units, namely, a pump unit 3 and a unit including the storage chamber 1 and the mixing head 2, which are connected through lines for conveying the suspension therebetween. It goes without saying that any pump 3 has a motor and is powered by an external energy source 9.

The storage chamber 1 and the mixing head 2 may form an integral component or can be attached to each other in some other way. In any event, the mutual arrangement of storage chamber 1 and mixing head 2 must guarantee that suspension can reach the storage chamber through an overflow 6 on well 4 and an upper opening 7 on the storage chamber 1. The storage chamber 1 is a cavity of any geometrical shape, which has e.g. a rotationally non-symmetric cross-section, especially an elliptical cross-section, polygonal cross-section or rectangular cross-section with a semicircular area or two semicircular areas on opposite rectangular surfaces. In the meaning of the invention, however, a rotationally symmetric, cylinder-shaped design is preferred. The cavity should have a size suitable for storage of a certain amount of microparticles for a specific use. In one embodiment of the invention the storage chamber 1 can therefore be replaced by the user. The storage chamber is filled either manually or by machine, the latter offering the advantage of potential automation.

The pump 3 conveys the suspension in a circulation by initially aspirating the suspension from the storage chamber 1. Pumps of any type of construction can be used to this end, as long as a minimum velocity of flow and thus transportation of particles is effected. Inter alia, the minimum velocity depends on the quality of the line connections and the properties of the suspension, including in particular the amount and mass of the particles as well as the viscosity of the carrier liquid. A person skilled in the art can determine the parameters experimentally using routine tests. The apparatus of the invention preferably uses a peristaltic pump.

The aspirated suspension is conveyed into the mixing head 2 by means of conveying lines, preferably via tubes 11. The mixing head comprises at least one cavity, a so-called well 4. In a preferred embodiment of the invention the mixing head 2 has eight wells 4, thereby allowing simultaneous processing of a plurality of samples. More specifically, this type of mixing head 2 is compatible with the 96-well format as represented by microtiter plates, for example. Upstream connection of the apparatus to high-throughput robots allows automation of processes in basic research as well as in the pharmaceutical, chemical, diagnostic and biotechnological industries.

The well 4 comprises an inflow zone 12, a zone having the flow turbulator 5, and a turbulent zone. The inflow zone 12 is located at the bottom of well 4, followed by the zone having the flow turbulator 5, and the turbulent zone thereabove. The transition from the zone having the flow turbulator 5 to the turbulent zone can be gradual. The cross-sections of the zones mentioned above preferably have the same geometrical shape. The geometrical shape is not limited as long as fitting of flow turbulator elements remains possible. Regarding possible forms, reference is made to storage chamber 1. In a preferred embodiment of the apparatus the well 4 has a rotationally symmetric cross-section.

The well 4 is designed in such a way that turbulent flow can be generated therein, to which end a flow turbulator 5 is fitted. In the meaning of the invention a “flow turbulator 5” can be any constructional measure on and/or in well 4 that involves both an external component connected or not to the well and the shape of the well 4 itself. Non-limiting examples of flow turbulators 5 are stirrers or shakers (as external, non-connected elements), pins or grids (as external, connected elements), discontinuous widenings or taperings of the cross-section as well as curvings of the lateral walls (as internal elements).

In a preferred embodiment of the invention the flow turbulator 5 comprises at least one discontinuous enlargement of the cross-section in a widening zone 13 above the inflow zone 12. The term “discontinuous enlargement” in the meaning of the invention relates to an abrupt widening of the diameter or cross-section, said widening being implemented along edges and therefore in the form of a step. The suspension flows through the inflow zone 12 which is followed by the widening zone 13. That is, the zone having the flow turbulator 5 is represented by the widening zone 13 in this embodiment. The widening zone 13 is preferably arranged in the lower half, more preferably in the lower third, especially preferably in the lower quarter of well 4. A large turbulent zone is ensured by an arrangement near the bottom.

Advantageously, the turbulence required to obtain a suspension with constant distribution can be adjusted through the design of the discontinuous enlargement. The turbulence level is determined by the combined effect of various parameters, including the relative height of the widening zone 13 relative to the overall height of well 4, the extent of the discontinuous enlargement and the type of step. In principle, the relative height of the widening zone 13 should be selected as small as possible so as to ensure a large turbulent zone. The height of the widening zone 13 is preferably less than 25% of the height of well 4, more preferably less than 15%. Inter alia, this is determined by the inclination of the interior walls in the widening zone 13. In a preferred embodiment of the present invention the cross-section in the widening zone 13 increases linearly with a tan φ slope of less than 70°, more preferably less than 50°, especially preferably less than 30°. In a particularly preferred embodiment the well 4 is designed in the form of a cylinder so that it diverges conically in the widening zone 13 with the slope mentioned above. As an additional parameter, the extent of discontinuous enlargement must be dimensioned such that sufficient space for flow stall at the interior wall and turbulence is available and that this space can be filled with turbulence. The discontinuous enlargement is designed in such a way that the cross-section in the widening zone 13 increases at least twofold, preferably at least fivefold and more preferably at least tenfold.

As an additional structural element the well 4 includes an overflow 6 which is situated in the upper portion of the turbulent zone. This ensures that the conveyed inflow does not cause overflowing of well 4 when there is no withdrawal or merely withdrawal of suspension where the withdrawn volume is smaller than the inflowing volume. The overflow 6 is a jacketed cavity in well 4, the length of which corresponds to at least the wall thickness of well 4. The overflow 6 preferably has a length exceeding the wall thickness of well 4. Furthermore, the overflow 6 is inclined in such a way that the suspension can flow off. The mixing head 2 is preferably arranged above the storage chamber 1 so as to allow gravity-forced outflow of suspension situated at or above the level of overflow 6 into the storage chamber 1 below. In particular, the overflow 6 is arranged above the widening zone 13 preferred according to the invention. It is of course also possible to position the mixing head 2 at the same level as or even a lower level than the storage chamber 1 and initially collect the overflowing suspension in a basin prior to returning it into the storage chamber 1 by means of a pump or by utilizing capillary forces. To this end, an opening 7 representing the upper open area of storage chamber 1 or another opening can be used, and, when applying external pressure to the line leading to the opening, the latter may also be situated below the liquid level in storage chamber 1.

One precondition for withdrawal of suspension is that the well 4 has an interface 8 to an adjoining laboratory system 10. For example, this laboratory system 10 can be a liquid handling robot that sucks off suspension by means of sampling needles. The interface 8 can be understood as the suspension surface, for example. The sampling needles immerse in the suspension at the interface 8. To avoid repeated adjustment of the immersion depth of the sampling needles, an interface 8 at a constant level is desired, such as provided by the invention. By virtue of the inventive arrangement and design of pump 3, storage chamber 1 and well 4 (each having at least two openings), which enable conducting the suspension in a circulation, a quasi-static state is generated with respect to turbulence and the position of interface 8 in the well 4.

The invention is also directed to the use of the apparatus according to the invention for uniform distribution of microparticles in a liquid. In other words, the invention also relates to the use of the inventive apparatus for obtaining a suspension of uniformly distributed microparticles in a carrier liquid and/or maintaining uniform distribution of microparticles in a carrier liquid. Furthermore, the invention relates to the use of the apparatus according to the invention for withdrawing a suspension of uniformly distributed microparticles in a liquid, preferably using a liquid sampler. The above teaching of the invention and the embodiments thereof relating to the apparatus per se are valid and applicable without restrictions to the use thereof, if deemed reasonable.

In one embodiment of the use according to the invention the apparatus is employed for the identification, characterization and/or purification of proteins. Proteins are frequently involved in the development of serious diseases such as cancer or Alzheimer's disease. Microparticles with a diameter of from a few micrometers to 0.1 mm gain increasing importance in protein analysis. Their surface has various reactive properties, allowing identification and characterization of proteins. Further, laboratory automation in the field of protein characterization and identification represents a growing market so that high-throughput robots are indispensable in effectively designing microparticle-supported proteome research. The apparatus according to the invention is constructed in such a way that a liquid handling robot can withdraw a suspension with constant distribution by means of sampling needles from the wells 4 of a mixing head 2, preferably from a mixing head having eight wells. Thus, upstream connection of the apparatus to high-throughput robots is possible. In a preferred fashion the inventive use of the apparatus is suitable for providing amounts of microparticles with constant distribution to perform automated protein purification processes using chromatography in a 96-well batch format.

In another preferred embodiment of the use the apparatus of the present invention is utilized in enzyme activity determination by means of mass spectrometry. As repeatedly demonstrated, mass spectrometry is a rapid, sensitive and reliable tool for determining enzymatic activities (Hsieh et al. 1995, Anal. Biochem. 229, 20; Bothner et al. 2000, J. Biol. Chem. 275, 13455; Wu et al. 1997, Chem. Biol. 4, 653). MALDI-MS is remarkable for its resistance to buffer solutions and high suitability for analyzing complex mixtures, for which reason it is predestined for direct screening of enzyme activities wherein a minimum of sample preparation is required. Mass spectrometry-assisted enzyme screening (MES) allows determination of enzymatic activities in complex protein fractions with a mass spectrometer. The principle will be described in brief herein, while a detailed description can be found in the articles by Jankowski et al. 2001, Anal. Biochem. 290, 324; as well as Schluter et al. 2003, Anal. Bio anal. Chem. 37, 1102, both incorporated by reference in their entirety in the present application. The analytic procedure is based on covalent immobilization of proteins on microparticles, thereby preventing proteolytic degradation and achieving removal of such molecules from the protein fraction, which would interfere with the mass spectrometric detection of enzymatic reaction products. The enzyme activity is determined by incubating the immobilized proteins with a reaction-specific probe, followed by analyzing the reaction mixture by means of MALDI-MS after well-defined periods of incubation. It is only the use of the apparatus according to the invention that ensures a suspension of microparticles with constant distribution and, as a consequence, uniform surface loading and constant protein concentration, so that identical amounts of microparticles can be withdrawn for incubation with the probe and reproducible data are generated.

The invention is also directed to a method of uniformly distributing microparticles in a liquid, using the apparatus according to the invention.

Furthermore, the invention teaches a method of uniformly distributing microparticles in a liquid, including the following steps:
(a) filling a storage chamber 1 with a suspension of microparticles and liquid,
(b) aspirating the suspension from the storage chamber 1 with a pump 3 via a suction means 17,
(c) conveying the aspirated suspension into a mixing head 2 which has at least one well 4,
(d) transferring the suspension into well 4,
(e) generating a turbulent flow in well 4,
(f) transferring the suspension above overflow 6 through an opening 7 and into the storage chamber 1, and optionally
(g) repeating the steps (b) through (f),
   characterized in that a circulation parallel to steps (b) through (g) is conducted, including the following steps:
(b′) aspirating the suspension from the storage chamber 1 with a pump 3 via a rotary runback 16,
(c′) conveying the aspirated suspension in a rotary loop,
(d′) transferring the suspension into the storage chamber 1, via a rotary inlet 15,
(e′) generating a turbulent flow in the storage chamber 1, and optionally repeating the steps (b′) through (e′).

The above teaching of the invention and the embodiments thereof relating to the apparatus and method are valid and applicable without restrictions to the method for the uniform distribution of microparticles, if deemed reasonable.

As is clear from the sequence of steps, the method proceeds in a circulation, to which end two openings of the storage chamber 1 and the mixing head 2 are essential, each one being different from the other. That is, the suction means 17 for aspirating the suspension towards the mixing head 2 and the opening 7 for receiving suspension overflown from mixing head 2 as well as the inflow 13 of suspension from the storage chamber 1 in well 4 in the mixing head 2 and the overflow 6 for returning the suspension into the storage chamber 1 are situated in the storage chamber 1. Step (g) is performed until the storage chamber 1 is empty or mixing of the particles is no longer desired because withdrawal and/or analysis of the particle suspension have been finished.

The turbulent flow in step (e) can be effected by any measure resulting in a Reynolds number above the critical value of 2300. In particular, suitable measures are increasing the suspension flow rate, the surface roughness of well 4 and/or the density of the suspension and/or reducing the dynamic viscosity. In a preferred embodiment of the method, turbulent flow is generated by fitting a flow turbulator 5, more preferably by incorporating at least one discontinuous enlargement of the cross-section in a widening zone 13 above the inflow zone 12.

The method can also be performed in such a way that step (e), (f) or (g) is followed by an additional step (h) wherein suspension is withdrawn by a liquid sampling robot.

Thus, as part of the present invention, an apparatus and a method for the uniform distribution of microparticles in a liquid are provided for the first time. The invention utilizes the design of a perfused sampling well 4 to generate turbulence in a simple and reliable way, which in turn results in a constant mixing state of microparticles in a suspension. Advantageously, the separation of storage chamber 1 and mixing head 2 allows uniform distribution of the microparticles at the site of withdrawal or analysis of the particles (well 4). According to the invention, this system is coupled with a second circulation which makes sure that the distribution of the microparticles remains homogeneous for a prolonged period of time, i.e. both at the beginning and at a point in time where the apparatus has been in operation for some time. Moreover, parallel sample processing is ensured in that the mixing head 2 has a plurality of wells 4 which, controlled as a whole, show identical mixing of the microparticles and are therefore useful in automated metering of microparticle quantities. While the prior art merely describes perfusion with gas, the flow of the suspension itself is utilized herein. By virtue of the surprising combination of turbulence with an overflow 6, a liquid circulation is formed which results in a quasi-static state in the wells 4. Apparatus and method of the invention are remarkable for their simple and cost-effective handling and present a variety of potential fields of uses, including particularly biochemistry.

It will be appreciated that this invention is not restricted to the specific methods, compositions and conditions as described herein, because such things may vary. It will also be appreciated that the terminology used herein solely serves the purpose of describing particular embodiments and is not intended to limit the protective scope of the invention. As used in the present specification and in the appended claims, singular word forms such as “a” or “the” encompass the corresponding plural forms unless the context unambiguously dictates otherwise. For example, reference to “a flow turbulator 5” includes a single turbulator or a plurality of turbulators which can be identical or different, or, reference to “a method” includes equivalent steps and methods well-known to those skilled in the art.

With reference to non-limiting examples of concrete embodiments, the invention will be illustrated in more detail below.

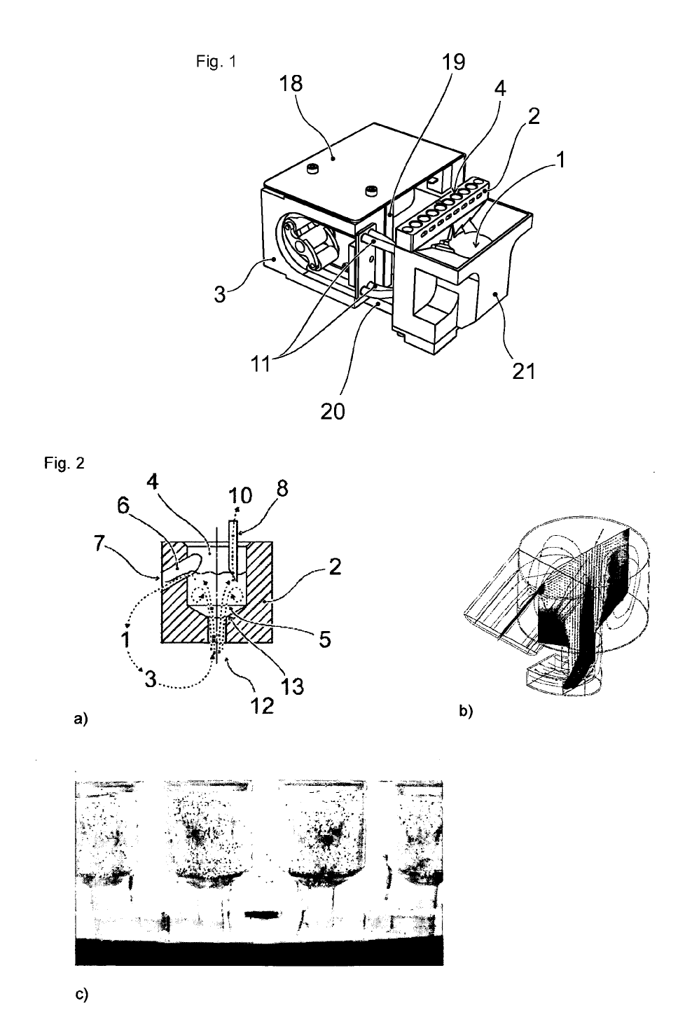

FIG. 1 shows a schematic drawing of the components of the apparatus for uniformly distributing microparticles in a liquid without the rotary circulation.

FIG. 2 shows a well 4 for withdrawal of suspension: a) schematically, b) in flow profile, and c) during operation of the apparatus.

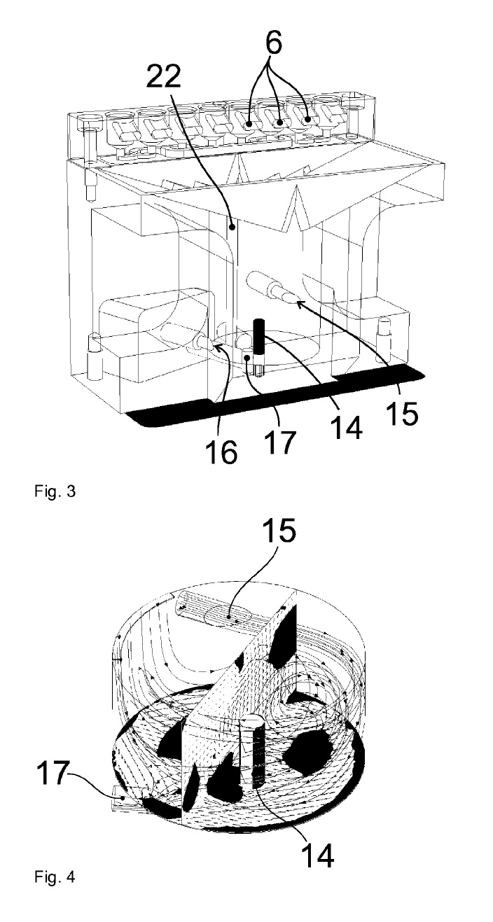

FIG. 3 shows a schematic drawing of the suspension mixer cylinder chamber including the rotary circulation with the constructional elements which elucidate the flow circulations.

FIG. 4 shows a CFD of storage chamber 1.

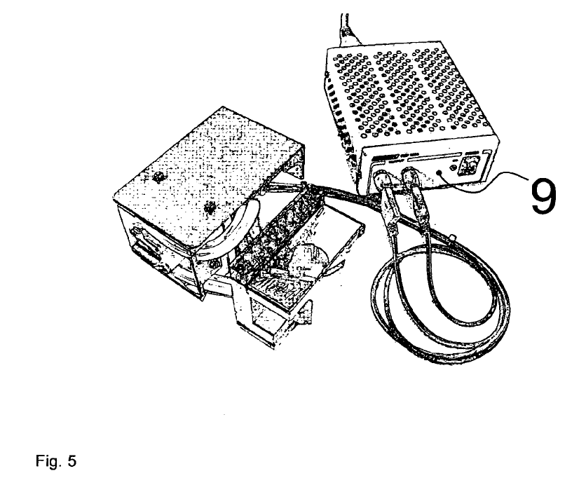

FIG. 5 shows the prototype of the overall system.

### EXAMPLE

The prototype of the overall system as illustrated in FIG. 5 includes a 12 V power supply as energy source 9, which supplies the overall system with electric energy. The energy source drives the pump 3 which is a Watson Marlow 102R type peristaltic pump driven by a 3540K024C Faulhaber motor. Pump 3 and motor are actuated by a switch.

Referring to FIG. 1, pump 3 and motor are covered with a cover 18 for protection against external influences, which is fixed on a flange plate 19 by means of DIN 912 (M4×10) screws. This type of screw is also used for all other fixings. The pump 3 as well as the suspension mixer cylinder chamber are mounted on a base plate 20. The suspension mixer cylinder chamber comprises the storage chamber socket 21, the mixing head 2, a type DIN 7 (3×15) cylinder pin 14, and four Connector M6 250-6 type connecting elements. The storage chamber socket 21 of the suspension mixer cylinder chamber is screwed on a base plate 20. The socket 21 has a cylinder-shaped storage chamber 1 in the center thereof, and an 8-well mixing head 2 is screwed on thereabove.

As can be seen in FIG. 2, the wells or withdrawal wells 4 are shaped in such a way that the conveyed inflow becomes turbulent as a result of a discontinuous widening of the duct in the entry zone (widening zone 13). In this way, the suspension in well 4 is swirled up and mixed thoroughly. Withdrawal of suspension by the liquid handling robot reduces the overall volume in the system. The wells 4 have an overflow 6 to achieve a constant liquid level for withdrawal of suspension.

The pump conveys the suspension in two parallel circulations (FIG. 3). The first circulation supplies the withdrawal wells 4 (FIG. 2a, 3). The suspension is aspirated at a cylinder-shaped suction means 17 and conducted through tubes 11. The suspension enters the mixing head 2 through a riser pipe 22 and is conveyed to the inflow zone 12 of each single well 4 by means of a line system. The overflowing liquid flows directly into the storage chamber 1 through opening 7. It is thus a liquid circulation in which a quasi-static state is generated in well 4 from which suspension with constant distribution is withdrawn.

The second circulation provides for rotation of the stored suspension in the storage chamber 1 (FIG. 3, 4). To this end, suspension is aspirated through a rotary runback 16, conveyed through a rotary loop in tubes 11, and returned into the storage chamber 1 via a rotary inlet 15. The storage chamber 1 has a cylinder-shaped pin 14 which swirls the rotating flow in such a way that no beads can deposit in the center of the chamber (much like a teacup with tea crumbs). The suction means 17 that feeds the withdrawal wells 4 through the riser pipe 22 is situated in the stagnant water of the pin.

### LIST OF REFERENCE NUMBERS

1 Storage chamber
2 Mixing head
3 Pump
4 Well
5 Flow turbulator
6 Overflow
7 Opening
8 Interface
9 Energy source
10 Laboratory system
11 Tubes
12 Inflow zone
13 Widening zone
14 Pin
15 Rotary inlet
16 Rotary runback
17 Suction means
18 Cover
19 Flange plate
20 Base plate
21 Socket
22 Riser pipe

1-14. (canceled)

15. An apparatus for uniformly distributing microparticles in a liquid, said apparatus comprising a storage chamber (1) including a suspension of microparticles and liquid, a mixing head (2) for receiving the suspension, and a pump (3) which is connected to the storage chamber (1) and the mixing head (2) for sucking the suspension from the storage chamber (1) into the mixing head (2), said mixing head (2) having at least one well (4) with a flow turbulator (5) and an overflow (6) which is connected to the storage chamber (1) via an opening (7), wherein the storage chamber (1) has a rotary inlet (15) and a rotary runback (16) which are connected to the pump (3) for generating a second suspension circulation.

16. The apparatus as claimed in claim 15, wherein the apparatus further comprises a pin (14).

17. The apparatus as claimed in claim 15, wherein the flow turbulator (5) is at least one discontinuous enlargement of the cross-section in a widening zone (13) above the inflow zone (12).

18. The apparatus as claimed in claim 17, wherein the cross-section in the widening zone (13) increases at least twofold, preferably at least fivefold and more preferably at least tenfold.

19. The apparatus as claimed in claim 17, wherein the cross-section in the widening zone (13) increases linearly with a tan Φ slope of less than 70°, more preferably less than 50°, especially preferably less than 30°.

20. The apparatus as claimed in claim 17, wherein the well (4) has a rotationally symmetric cross-section and diverges conically in the widening zone (13).

21. The apparatus as claimed in claim 17, wherein the aspirated suspension in well (4) forms a constant-level interface (8) to a liquid withdrawal robot.

22. The apparatus as claimed in claim 17, wherein the mixing head (2) has eight wells (4).

23. A method for the uniform distribution of microparticles in a liquid, said method comprising the following steps:
(a) filling a storage chamber (1) with a suspension of microparticles and liquid,
(b) aspirating the suspension from the storage chamber (1) with a pump (3) via a suction means (17),
(c) conveying the aspirated suspension into a mixing head (2) which has at least one well (4),
(d) transferring the suspension into the well (4),
(e) generating a turbulent flow in the well (4),
(f) transferring the suspension above an overflow (6) through an opening (7) into the storage chamber (1), and optionally
(g) repeating the steps (b) through (f),
wherein a circulation parallel to steps (b) through (g) is conducted, comprising the following steps:
(b′) aspirating the suspension from the storage chamber (1) with a pump (3) via a rotary runback (16),
(c′) conveying the aspirated suspension in a rotary loop,
(d′) transferring the suspension into the storage chamber (1) via a rotary inlet (15),
(e′) generating a turbulent flow in the storage chamber (1), and optionally repeating the steps (b′) through (e′).

24. The method as claimed in claim 23, wherein the turbulent flow in step (e) is generated by fitting a flow turbulator (5) by fitting at least one discontinuous enlargement of the cross-section in a widening zone (13) above an inflow zone (12).

25. The method as claimed in claim 23, wherein at least one of steps (e), (f) or (g) is followed by an additional step:
(h) withdrawal of suspension by a liquid sampling robot.
